(19) United States
(12) Patent Application Publication
(10) Pub. No.: US 2007/0021944 A1
(43) Pub. Date: Jan. 25, 2007

(54) Municipal cleaning systems and methods

(76) Inventor: Moise Maurice Levy, Pittsfield, MA (US)

Correspondence Address: HAHN LOESER & PARKS, LLP, One GOJO Plaza, Suite 300, AKRON, OH, 44311-1076, US

(21) Appl. No.: 11/187,426

(22) Filed: Jul. 22, 2005

(51) Int. Cl. G06F 11/00

(52) U.S. Cl. 702/188

(57) ABSTRACT

The present invention provides systems and methods for cleaning a municipality, factory or the like. The system and methods may include deploying a plurality of mobile cleaning systems, wherein each mobile cleaning system is equipped with a monitoring system and a communications system. The mobile cleaning systems communicate with a central control facility in implementing cleaning operations, and information relating to cleaning tasks can be gathered and used in optimizing or creating cleaning operations for that or other municipalities for example. The monitoring systems associated with the mobile cleaning system may include a position of location sensing system, so the location and movement of the mobile cleaning system can be monitored by the central control. According to the invention, cleaning operations performed for municipalities, factories, or the like, can be effectively designed and controlled to optimize use of cleaning system resources and personnel, providing an efficient and cost-effective structure for cleaning and maintenance of such areas or facilities.

### TECHNICAL FIELD

The present invention relates to municipal cleaning systems and methods. More particularly, embodiments of the present invention relate to methods and systems for facilitating the design and operation of municipal or other cleaning operations using various mobile cleaning systems, by means of monitoring, surveillance, recording and reporting relating to cleaning operations performed by the mobile cleaning systems. The invention provides systems and methods which enable the effective and efficient management and design of cleaning operations using environmentally friendly methods.

### BACKGROUND OF THE INVENTION

There is a need in a variety of environments to provide cleaning of areas and fixtures for optimum or safe use and/or aesthetics of the area. For example, in operating cities, towns, villages, private residential or business areas, country clubs or the like, it is desirable to provide an environment which appears clean and safe for the people working, living, playing or visiting there. In factory environments, cleaning of floors, equipment, fixtures or other surfaces or objects within the factory is required for increasing efficiency in factory operation and providing a clean, safe environment for workers. In these and other like environments, the need for effective and efficient cleaning of the surfaces, objects, the removal of trash or litter, and other clean operations, are desirable to promote these objectives. It may also be beneficial to increase the visibility of cleaning operations to those in the area, to communicate the value of a clean environment for their benefit provided by the municipality or management.

It is for these reasons that business owners of factories or the like, and service departments for municipalities or the like, typically purchase cleaning equipment so that the streets, sidewalks, aisles, corridors, parking lots, benches, tables, equipment, or any of a variety of other surfaces or objects can be cleaned.

For example, specialized vehicles have been developed for cleaning of streets, sidewalks or other surfaces, areas or objects. Such cleaning vehicles typically employ-either one or more types of cleaning devices, such as brushes, cleaning solution, vacuum suction or the like, to capture dirt and debris and clean surfaces. In many municipalities and factories for example, such cleaning vehicles are used in a routine, regular, systematic cleaning operation, wherein the cleaning vehicles are deployed via one or more operators to perform designated cleaning functions. For example, street or sidewalk cleaning may be performed periodically within a municipality, while cleaning of benches, gum removal, trash receptacles or the like are cleaned upon a different schedule, using different cleaning vehicles or equipment.

In managing such cleaning operations within a municipality, factory, commercial or other environment desired to be maintained, implementation is a burdensome and haphazard endeavor. Further, in the use of such cleaning vehicles or remote cleaning activities, it is difficult to monitor operation of the vehicle relative to desired cleaning tasks to be performed.

It would be worthwhile and desirable to provide systems and methods which would facilitate management and implementation of cleaning operations using cleaning vehicles of this nature, to more effectively control the cleaning operation within these types of environments.

It would further provide a significant advantage to allow the design of a cleaning operation by management of a cleaning operation based on data relating to cleaning operations to be performed. It would also be desirable to provide a cleaning operation which is visible to patrons of an area, while efficiently and effectively cleaning an area using environmentally friendly cleaning techniques. To provide such advantages, there is a need to provide cleaning systems and methods, wherein mobile cleaning systems are able to communicate to a central control for providing data relating to its operation or other information, and receive communications from central control.

It would also be desirable to provide a system and methods of cleaning a municipality or the like by providing a monitoring, surveillance, recording and reporting system that increases the efficiency of cleaning municipal or like areas.

### SUMMARY OF THE INVENTION

Based upon the foregoing, the present invention provides cleaning systems and methods wherein design and management of cleaning operations is greatly enhanced, and operations are conducted efficiently and effectively using environmentally friendly methods and systems. The invention provides a management system and methods which makes the cleaning operations visible in an area, and use environmentally friendly cleaning techniques to enhance the perception of the operations in an area. The invention also provides a system and method for acquiring data relating to cleaning operations, and the use thereof for designing and implementing cleaning operations. The invention provides the ability to learn and adapt from data acquired relating to actual cleaning operations to other environments and conditions for designing and monitoring such operations. The systems and methods may therefore comprise at least one central control facility comprising a processing system, and at least one mobile cleaning system for cleaning of designated areas and/or objects. The mobile system comprises a processing system, and a communication system capable of communicating with the central control facility, wherein the mobile system communicates with the facility during operation to direct cleaning of an area and monitor the operation of the mobile system. The system may be configured to monitor cleaning of a municipality, factory or any other area or environment. The central control may have a database server located at a central dispatching location, and each mobile cleaning system may be equipped with a portable monitoring system and a mobile communications system capable of transmitting and/or receiving data. One or more operators may be responsible for the operation of each mobile system to complete a designated set of cleaning tasks within a designated area or the like. The mobile systems may be networked to the database server, and the location, operation or other information may be sent via a communication system to be recorded at the central control.

The present invention also provides a method for maintaining the cleanliness of a municipality, factory or the like, the method providing a central control facility, and deploying a plurality of mobile cleaning systems, wherein each mobile system is equipped with a mobile communications system capable of transmitting and/or receiving data. Each mobile system is assigned various cleaning tasks within a designated area, and the central control system monitors the activity of the mobile systems to facilitate efficient completion of the cleaning tasks.

An embodiment of the present invention also includes a method for designing and implementing an operation to maintain the cleanliness of a municipality, the method comprising providing a central control having a system wherein a plurality of areas or objects within an area are identified for cleaning. Cleaning of the areas/objects are performed using at least one mobile cleaning system, with the central control communicating with the mobile system to monitor operation of the mobile system. The operation is monitored relative to predetermined cleaning operations for the plurality of areas or objects.

The objects and advantages of the invention overcome the limitations of the prior art and provide desired advantages to provide a highly efficient, well controlled cleaning operation for the cleaning of environments such as municipalities, factories, parks, commercial spaces or a variety of other environments, wherein mobile cleaning systems are used.

These and other advantages and novel features of the present invention, as well as details of illustrated embodiments thereof, will be more fully understood from the following description and drawings.

### BRIEF DESCRIPTION OF THE DRAWINGS

FIG. 1 illustrates a schematic diagram of the system and method for implementing a cleaning operation in a municipality, operable in accordance with an embodiment of the present invention;

FIG. 2 illustrates a schematic block diagram of a monitoring system in accordance with the present invention;

FIG. 3 illustrates an example of a mobile cleaning system used in cleaning the municipality in accordance with the present invention;

FIG. 4 illustrates another example of a mobile cleaning system used in cleaning the municipality in accordance with the present invention;

FIG. 5 illustrates a third example of a mobile cleaning system used in cleaning the municipality in accordance with the present invention;

FIG. 6 illustrates a mobile platform wherein a steam cleaning system is provided for use in cleaning in accordance with the present invention;

FIG. 7 illustrates a flow chart of an embodiment of a method to document the activity of the mobile cleaning systems, in accordance with the present invention;

FIG. 8 illustrates a flow chart of an embodiment of a method to design a cleaning operation, in accordance with the present invention; and

FIG. 9 illustrates a flow chart of an embodiment of a method to respond to a complaint or emergency requiring the use of the cleaning equipment, in accordance with the present invention.

### DETAILED DESCRIPTION OF THE INVENTION

The present invention provides systems and methods for designing and implementing cleaning operations for enhancing the efficiency, visibility and effectiveness of cleaning operations. The invention provides systems and methods which can be used by management for designing, monitoring and evaluating cleaning operations using a plurality of mobile cleaning systems for cleaning an area, objects or surfaces in an area. Using data relating to the performance of actual cleaning operations using mobile cleaning systems, the invention can further provide the ability to design a cleaning operation to maintain and clean an area according to a designed cleaning program. The invention also provides for the use of environmentally friendly cleaning operations to enhance the effectiveness and perception of a cleaning program.

As will be recognized from a further reading regarding embodiments of the invention, the invention is not limited to use in any particular cleaning operation or area, but is applicable to a wide variety of cleaning operations and areas or environments in which the cleaning operations are implemented. Although embodiments as described herein reference cleaning operations performed within areas such as municipalities, cities, parks, factories, or other similar areas or environments, it should be understood that the invention is not limited to such operations, areas or environments. Accordingly, the term “municipalities”, shall mean, for purposes of the invention, any such environment, including cities, towns, villages, residential community, business district, commercial space, factory, park, school, domicile or any like environment in which mobile cleaning systems are utilized for implementation of systematic cleaning operations in an area. Alternatively, these types of areas and facilities may be referred to as “premises”.

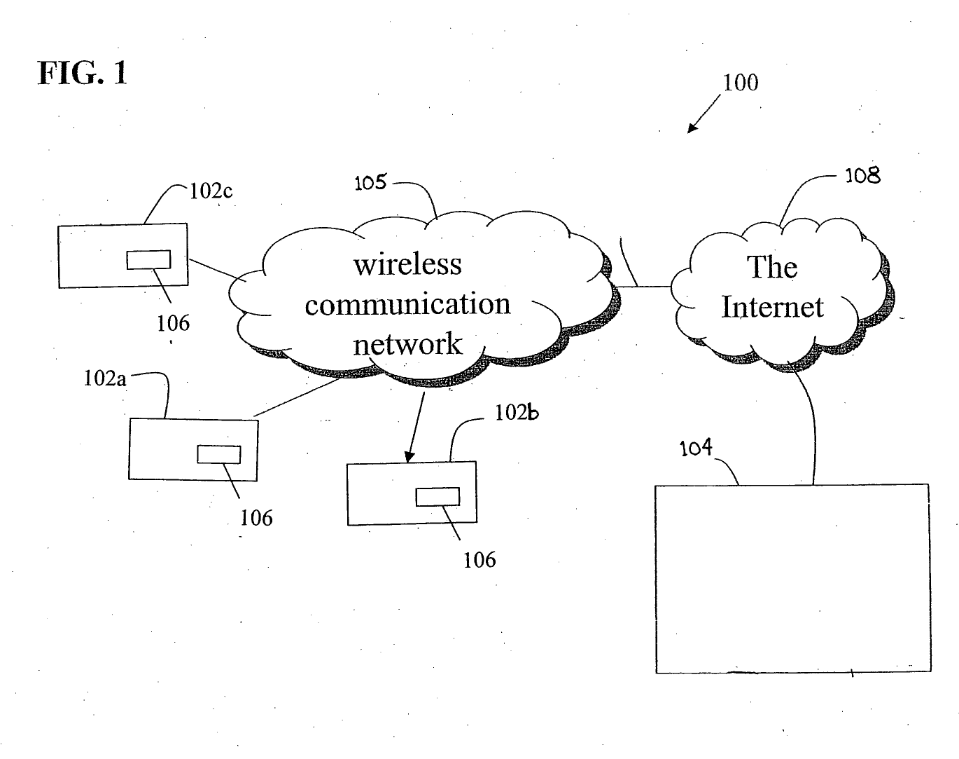

Thus, a first embodiment will be described with respect to a cleaning system and operation within a municipality. In particular, the system and methods may be used to clean exterior surfaces, such as street cleaning, spot cleaning and degreasing, chewing gum removal, graffiti/poster removal, ashtrays, litter bins and other refuse-holding containers, or any other surfaces or objects in the environment. An embodiment provides monitoring, surveillance, recording and reporting of cleaning activities in real time as will be described in more detail herein, but again, the invention is not limited to implementation only in this manner, and non real time operations may be performed while still gaining various advantages according to the invention. As seen in FIG. 1, a municipal cleaning system 100, configured to monitor and direct the cleaning of a city or the like, includes a plurality of mobile cleaning systems 102a, 102b and 102c. In the system and methods according to the invention, it may be desirable to provide for acquisition and communication of data to and from the plurality of mobile cleaning systems 102, providing the ability to monitor and implement cleaning operations for each of the mobile systems 102. According to embodiments, data relating to operation of the mobile cleaning system is selectively or automatically communicated to and from the mobile system 102 and a central control facility 104. The data acquired and utilized according to the present invention depends in part upon what types of cleaning systems are being used, and/or in relation to the cleaning tasks or environment being cleaned, as examples. Various operational parameters may be selectively monitored by means of a monitoring system 106 associated with the mobile cleaning systems 102.

As merely an example, the monitoring system 106 may be used to monitor and communicate data to the central control facility 104, wherein such operational data may be stored for creating records associated with operation of the cleaning system. Alternatively, as will be described hereinafter, such data may allow processing thereof for designing cleaning operations for particular cleaning tasks to be implemented by a particular mobile cleaning system 102, and/or designing the entire cleaning operation for a particular municipality or other area. The monitoring system 106 may also provide a system for identifying the location of the mobile cleaning system 102, such as GPS or cellular networks, to allow evaluation of progress in a deployment operation of the mobile cleaning system 102, as well as other beneficial aspects. Knowledge of the location of each of a plurality of mobile cleaning systems 102 can allow effective and efficient implementation of cleaning operations via a central control facility 104. The monitoring system 106 may be used to generate data relating to various operational characteristics of the mobile system, such as location, operational parameters of various cleaning systems aboard the mobile system 102, operator information, status of cleaning solutions or other materials aboard the mobile system 102, time, or any of a variety of other data relating to the mobile system 102 and/or its operation. The monitoring system 106 is coupled to a communication system 105 for transmitting and receiving information from the central control facility 104, in any suitable format, and by any suitable communication system. As an example, wireless communication from the mobile system 102 to the central control facility 104 may be provided through any suitable wireless network 105, but other communication systems are contemplated. For example, cellular or other systems may be utilized as desired, as long as such systems provide transmission and/or receipt of information for purposes of the invention. The central control facility 104 may comprise a computer system for performing operations according to the invention, and for storage and processing of data and/or implementation of cleaning operations via software stored therein by means of the mobile cleaning systems 102.

In an embodiment, the central control facility may comprise a central processing system, which may serve as a central facility for data from or to the mobile systems 102 to be handled, or for other various system resources. Those skilled in the art will appreciate that a central computer system may be a single computer or may be comprised of several computers, processors, and/or servers. Such processing systems may be several of such devices together or remote to each other, or any suitable combination thereof. Each mobile cleaning system is uniquely identified and tracked, so that the central processing system can acquire information and implement cleaning operations of the various mobile cleaning systems deployed throughout the municipality. The central control facility may also comprise other resources, such as personnel to receive and place voice, digital or other communications with an operator of a mobile system 102 or other personnel, such as inspectors who may be charged with visually inspecting the cleaning operations being performed for quality control. It should also be understood that the term “central” does limit the invention in terms of location or type of the facility, but merely serves to identify the preferred accumulation of information and data relative to a cleaning operation performed by a plurality of mobile cleaning systems. Similarly, the term “facility” does not limit the invention to any particular type or kind of resources, and the “facility” may be of any suitable type to allow monitoring of mobile cleaning systems 102 as desired, and/or to send or receive data to such mobile systems. The “facility” may thus simply be a computer system or server, or can include a variety of other resources. As an example, the data relating to cleaning operations performed by a mobile system 102 may be acquired during use and later input to the “facility” manually or electronically, rather than communicating in real time.

In an embodiment, the central control facility 104, may be a website of a global information system, with the site located on a computerized information network, such as the Internet 108. The website may be operated by a wireless application service provider (“WASP”). Alternatively, a private information network may be established for implementing the systems and methods according to the invention. As merely an example, a municipality may establish a web site relating to its cleaning program and operations, which would provide information to the general public, as well as possibility allow other functions to be implemented, such as the reporting of spills or other conditions which require cleaning. Thus, upon noting a condition to be brought to the attention of the management implementing cleaning operations for the municipality, mobile cleaning systems 102 in the vicinity of the noted problem may be deployed for appropriate clean up operations. The ability for the central control facility 104 to communicate with any mobile cleaning system 102 and operator, if any, allows for quick response to any such situations.

Monitoring system 106 may be provided in association with or integrated with the mobile systems 102. For example, monitoring system 106 may be integrated into the mobile system, as is a radio into a car, and powered by a suitable power source, such as a vehicle power source (e.g., car battery). Alternatively, a monitoring system 106 could be retrofitted to the mobile cleaning system for use therewith. The monitoring system 106 may be configured to allow use by a plurality of individuals (depending on the individual operating the mobile cleaning system, for example). Also, although discussed relative to specific examples or embodiments of the monitoring system 106, the functions performed by the monitoring system 106 can vary based upon desired objectives. Thus, the monitoring system 106 may be provided as an interactive system requiring input and control by the operator, or may simply be a passive system that does not require any operator control or intervention, or any combination thereof. Further, the monitoring system could provide a variety of functions besides those discussed in the embodiments herein, to allow other specific functionality to facilitate implementation or operation of a cleaning system or operation, communication, data acquisition, monitoring functions, equipment information, operator information, or other information or processes.

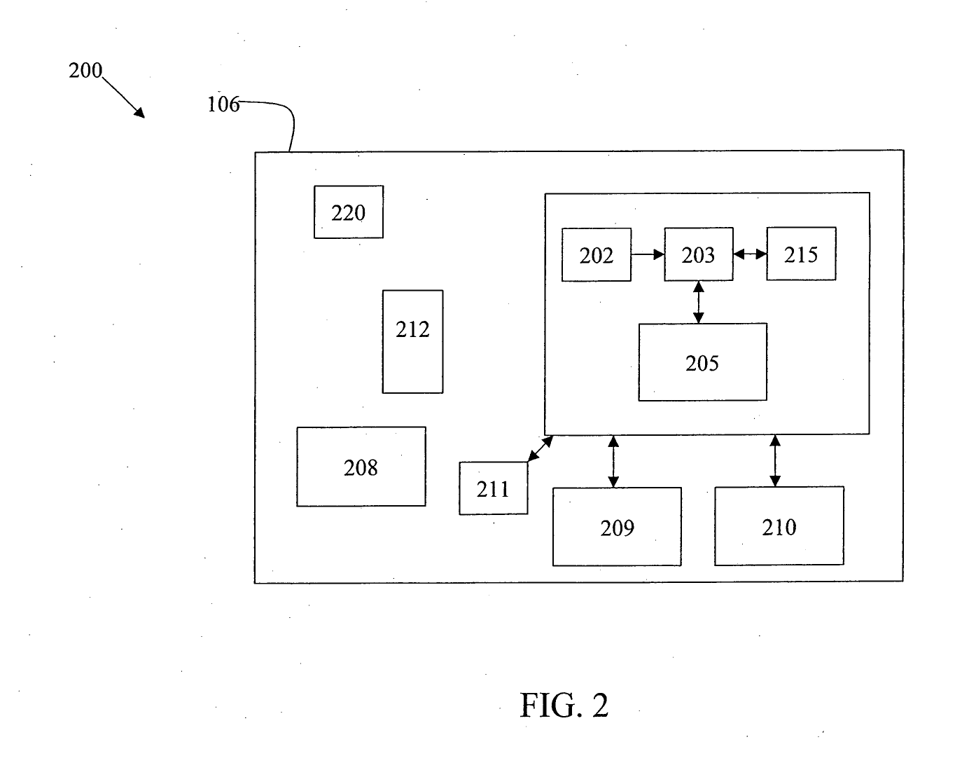

An example of a monitoring system 106 according to the invention may be more fully appreciated with respect to an embodiment as shown in FIG. 2. The monitoring system 106 may comprise a processor 201, having a central processing unit (CPU) 203 and various types of memory. The memory may include program memory 205, which provides long-term storage of functional code, read only memory (ROM) 202, and random access memory (RAM) 215. Alternatively, the processing system 201 may be a simple system for acquiring and transmitting data from the mobile cleaning system 102, or simply acquiring and storing data for later transmission to a central database as an example. Communication with the monitoring system 106 may be implemented automatically, or selectively by the central control facility 104 and/or an operator of the mobile cleaning system 102. The processor 201 may be used to implement software instructions if desired, or to perform any other desired capabilities as may occur to those skilled in the art. The monitoring system 106 may be powered by a battery source 208, or other suitable power source. To facilitate user interaction with monitoring system 106, a user interface such as a display 209 (e.g., liquid crystal display (LCD) or a touch sensitive display) keypad or other user interface 210, mouse 211 and other possible components such as an on/off power switch 212 may be provided. The keypad 210 could be an alphanumeric keypad, allowing input of text messages or the like. Additionally, display 209 could be used to display text and graphic messages, such as a city map detailing an area, surfaces and/or objects to be cleaned by a particular mobile cleaning system 102. Other communications or information relating to the cleaning operations to be performed, warnings, alerts, or the like, may also be displayed via the user interface.

In other embodiments, monitoring system 106 may include a pager, cellular telephone, email, personal digital assistant (PDA) functionality or some combination thereof. In various embodiments, portable transceiver functionality may be integrated into such devices. Monitoring system 106 may be configured to communicate with central processing system 105, and may also be configured to communicate with other systems via the Internet and Web systems, telephone networks, cellular telephone networks, and so on. The monitoring system 106 may also allow for communication with other sources of information, such as to read or receive information from sources such as barcodes, RFID devices or the like. For example, the monitoring system 106 may be configured to receive information from a barcode or RFID associated with a particular object, surface or area to be cleaned to indicate that such location was visited by the mobile cleaning system 102. Monitoring system 106 may be linked to such systems through the central control facility 104, or via other suitable means. Such systems may serve as information providers, receivers, or both to monitoring system 106. In such cases, display 109 of monitoring system 106 may also be configured to display e-mail messages, e-commerce information (e.g., ads), pager messages, news and other informational messages, updates and bulletins.

As described in more detail, an operator (not shown) of the mobile cleaning system uses a monitoring system 106 provided in association the mobile cleaning system 102, which monitors the location and movement of each mobile cleaning system, as well as other possible parameters, such as operational parameters of the mobile cleaning system 102. Thus the monitoring system 106 may comprise a variety of sensors, such as temperature, moisture, pressure, light, electrical equipment operating parameter sensors, or the like. The monitoring system 106 may be used to automatically or manually record operations and cleaning activities or other information as desired. Monitoring system 106 determines the position of the mobile cleaning systems from GPS or other location providing system, which is then relayed to central processing system 105 located within remote central facility 104.

For example, using GPS signals, the position of the mobile cleaning system 102 is known, and movement of the mobile cleaning system 102 can be monitored during a cleaning shift of an operator. The monitoring system 106 may automatically transmit position signals indicative of the current position of the mobile cleaning system 102 to remote dispatch center 104, and used along with other information, gathered automatically or manually, to monitor the progress of cleaning operations performed by the mobile system 102. In accordance with an aspect of the invention, a cleaning operation may be implemented by a computer program product, which will send information from the central facility 104 to a mobile cleaning system 102 for instructions on cleaning operations to be performed. As merely an example, information may be provided to an operator or robotic control system, detailing a cleaning operation to be performed, and the time allowable for the cleaning operation. If cleaning operations performed by a mobile system 102 are not commensurate with defined operational parameters as established under a predetermined cleaning program, an alert could be forwarded to the operator, or other suitable actions taken. Thus, cleaning of benches on a walkway, trash receptacles, ashtrays or other objects can be performed under established standards based upon the type of mobile cleaning system, the cleaning steps to be performed and time in which such steps can be implemented. It should be recognized that by defining cleaning operations more precisely, an efficient and repeatable cleaning operation is performed to optimize cleaning activities and efforts. It should also be recognized that providing the ability to monitor operation of a mobile cleaning system may allow management to evaluate operator performance for more effective management of employees or contractors who may be used to implement cleaning operations. These capabilities also allow management to effectively define a cleaning program for a particular municipality or area thereof, wherein a plurality of areas, objects, or surfaces within an area are identified for cleaning using at least one mobile cleaning system. The central control facility 104 communicates with the mobile system 102 to monitor operation of the mobile system, with operation monitored relative to the predetermined cleaning operations for the plurality of surfaces, areas or objects. Actual data relating to various cleaning operations may be acquired and used in the development of a defined cleaning program for a municipality.

In accordance with embodiments as described herein, the system and methods provide monitoring, surveillance, recording and reporting relative to cleaning operations and implementation of a cleaning operating for a municipality. To facilitate implementation of a cleaning operation for a municipality, additional steps may be warranted, such as actual inspection of particular cleaning operations relative to particular municipality assets. Additional personnel may perform inspection, or the mobile cleaning system itself may carry surveillance equipment, such as a video camera, to record the cleaning operation and successful completion, as an example.

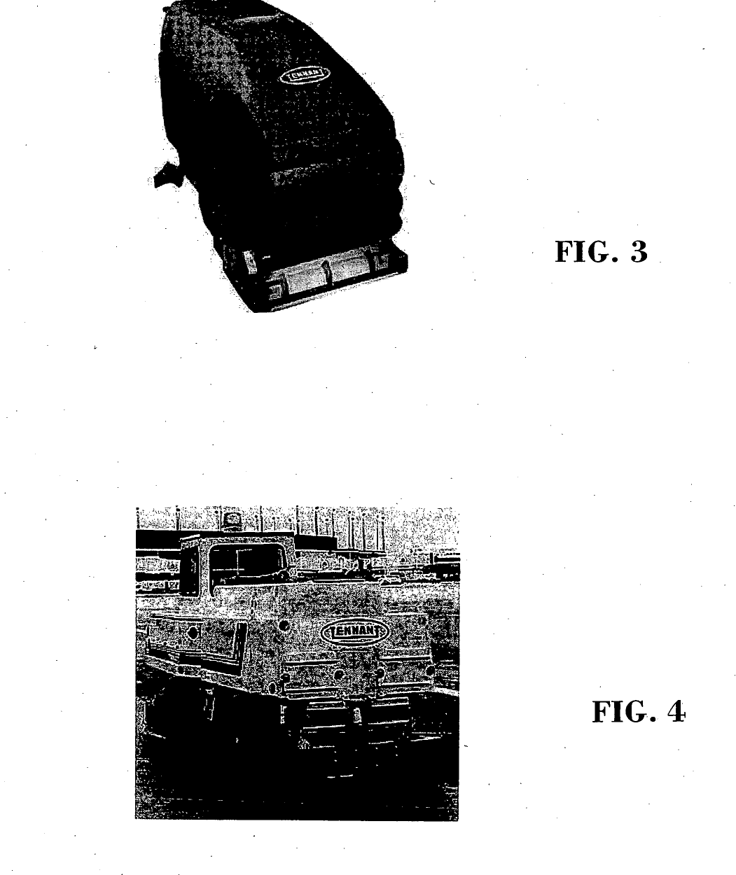

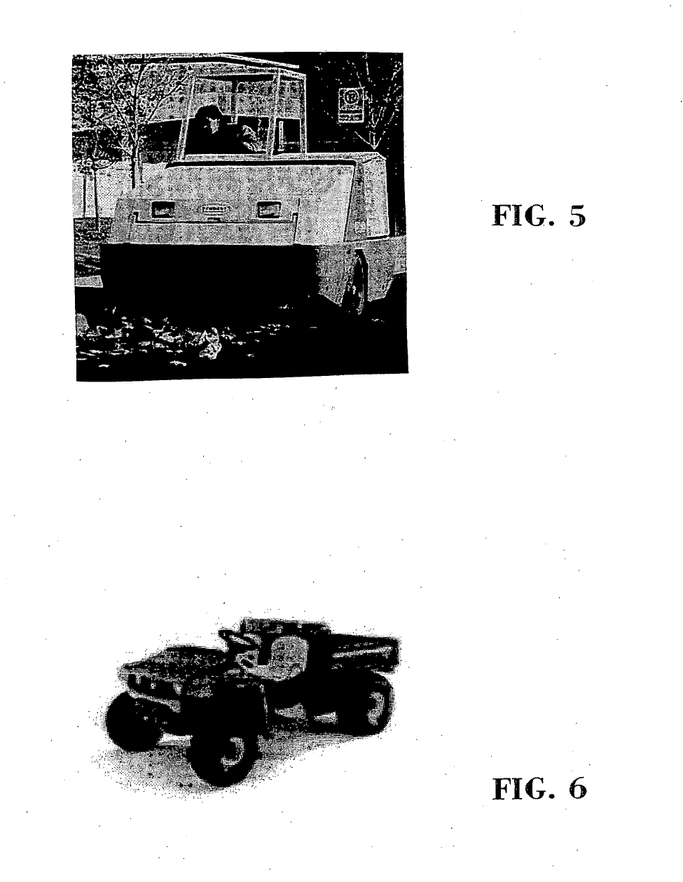

The mobile cleaning system 102 can take the form of a various known mobile cleaning machine modified to include an integrated monitoring system 106 or having system 106 retrofitted thereto. As an example, such systems 102 may take the form of a commercial road sweeper. These sweepers sweep surfaces efficiently and to practically eliminate secondary dust. The sweepers may have rotating brushes and vacuum fans that collect sand, salt residue, trash and road debris. An example of such a sweeper is the Tennant 830 II, produced by the Tennant Company of Minneapolis, Minn., as seen in FIG. 3. Other suitable machines 102 may take the form of a manual push-along/walk-behind scrubber. These scrubbers would be used to clean curb areas and to clean grease or other stains resulting from spills on a footpath. An example of such a push-along scrubber is the Tennant 5700, as seen in FIG. 4. Another machine may take the form of a riding sweeper. The role of the sweeper is to patrol and sweep and vacuum designated areas of the municipality. This machine is configured to pick up all kinds of litter including light debris, cigarette butts, beverage cans, bottles as well as dirt and dust. An example of such a sweeper is the Tennant Litter Hawk™, as seen in FIG. 5. In a preferred form, the mobile systems 102, such as machines of this type, may also be equipped with a low pressure saturated steam cleaning assembly having a chemical delivery system, such as described in U.S. patent application Ser. No. 11/055,388, which is incorporated herein by reference. The steam cleaning system comprises a housing a steam generating system for producing a low-pressure saturated steam. The steam dispensing system comprises a water reservoir and a pump feeding the water into a steam-producing boiler that is coupled thereto for dispensing the steam from a first outlet port. A cleaning solution dispensing system is provided having at least one reservoir for a cleaning solution and a pump system for dispensing an amount of the cleaning solution from the reservoir to a second outlet port. These first and second outlet ports are positioned adjacent to one another, such that a mixture of the cleaning solution and saturated steam is dispensed from the system. The steam cleaning system can be mounted and integrated onto vehicles and other mobile platforms including trucks, buggies, utility vehicles and automatic floor scrubbers, such as those shown in FIGS. 3-5. Alternatively, such a steam cleaning system could be incorporated into a vehicle to allow the system to be transported to a site for exterior cleaning applications, which by way of example, may be a buggy such as seen in FIG. 6. These exterior cleaning applications may include street cleaning, spot cleaning/degreasing, chewing gum removal, graffiti/poster removal and street furniture cleaning as examples.

The low pressure, saturated steam cleaning systems that may be provided on the mobile cleaning systems 102 may be used to clean and disinfect litter bins, ashtrays, to remove gum from a variety of surfaces, and to perform detailed maintenance work of various surface areas on a regular basis. The steam cleaning system is designed to perform such operations without generating run-off, with the steam generating systems using very low volumes of water and/or cleaning solutions. Using such a system, cleaning and disinfecting of surfaces can be achieved, thereby significantly reducing the risk of disease and eliminating foul odors which can develop due to microorganisms or the like. Disinfecting chemicals may also be used or degreasers or the like, to facilitate cleaning operations as desired.

It should be recognized that according to the invention, cleaning operations performed for municipalities, factories, or the like, can be effectively designed and controlled to optimize use of cleaning system resources and personnel, providing an efficient and cost-effective structure for cleaning and maintenance of municipalities.

With reference to the description of the systems and methods according to the invention, a person of ordinary skill in the art would appreciate that the invention may be embodied as a system, method, data processing or acquisition system, and/or a computer program product. As such, the present invention may take the form of an embodiment comprised entirely of hardware, an embodiment comprised entirely of software or an embodiment combining software and hardware aspects. In addition, the invention may take the form of a computer program product on a computer-readable storage medium, having computer-readable program code embodied in the medium.

The present invention is described with reference to flowcharts or block diagrams that illustrate methods, apparatus or systems, but it should be understood that each block of the various figures and combination of blocks in the flowcharts, could be implemented by hardware, or computer program instructions. Such computer program instructions can be loaded onto a general-purpose computer, special purpose computer, or other programmable data processing device to produce a machine, such that the instructions that execute on the computer or other programmable data processing apparatus create means for implementing the functions specified in the present invention. The instructions may also be stored in a computer-readable memory that directs a computer or other programmable data processing device to function in a particular manner, such that the instructions stored in the computer-readable memory produce an article of manufacture including instruction means which implement the functions specified in the flowcharts or diagrams. The computer program instructions may also be loaded onto a computer or other programmable data processing apparatus, to cause a series of operational steps to be performed on the computer to produce a computer implemented process, such that the instructions which execute on the computer or other programmable apparatus provides steps for implementing the functions specified according to the invention.

It should also be understood that blocks of the flowchart support combinations of systems for performing the specified functions, combinations of steps for performing the specified functions and program instructions for performing the specified functions. It is also to be understood that each block of the flowcharts or diagrams, in combinations of blocks in the flowcharts or diagrams, can be implemented by special purpose hardware-based computer systems, which perform the specified functions or steps, or combinations thereof.

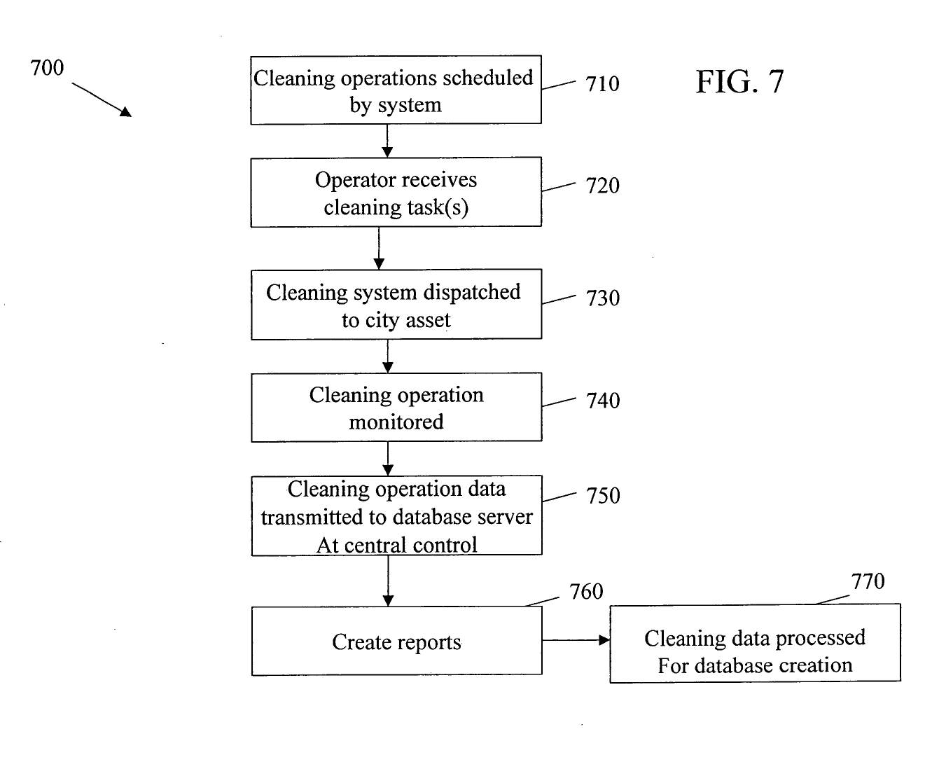

As seen in the FIG. 7, the flowchart 700 details a method of monitoring and recording the activity of the mobile cleaning systems. In general, a system according to the invention may provide software for the management of a cleaning operation with which to design, implement and monitor a cleaning operation for a particular municipality. As an example, cleaning operations to be performed for a particular municipality or the like are identified and scheduled by the system, as seen in step 710. Cleaning operations to be performed by a plurality of mobile cleaning systems are scheduled and communicated to an operator of a mobile system, as at 720. Based upon the cleaning operations to be performed, the mobile cleaning system is dispatched to perform certain cleaning functions, for example, the cleaning of city assets such as streets or sidewalks, at 730. The system of the invention can then monitor the cleaning operation, for example in real time, indicated at 740, via the system 106 as previously described. The data acquired relating to a cleaning operation performed may be transmitted, either in real time or at a later time, to the central control at 750 the data so acquired may then be used to create reports relating to the cleaning operation, such as at 760, or may be processed for database creation, such as at 770, or may be used for other purposes as desired. It should be recognized that according to the invention, the step of monitoring cleaning operations at 740 may be conducted in a variety of manners, such as by automatically monitoring and recording operation of the system 102. Alternatively, the operator of the system 102 may manually facilitate such monitoring, such as by using an interface on the system 106 to indicate the “start” and “stop” of a cleaning operation or the like. Also, the information may be stored for later download to a database instead of transmitting it directly to the central control 104.

The system and methods of the present invention may thus be used to record data relating to the cleaning operations and activity of any mobile cleaning system 102. For example, the time and duration of each cleaning task performed. This information can be used, along with other information, such as the time taken to travel from location to the next to perform cleaning functions, to create reports 760 or the like. These reports can be used to manage the cleaning operations and operators. In this case, the reports may assist management in determining if the operator requires further training, if the cleaning task was actually performed or if the operator exhibited delinquent behavior. The reports could also be used for statistical analysis. In this case, the results can be used to optimize the efficiency of the cleaning system. In particular, the statistics can be used to achieve better coordination between the various deployed mobile cleaning systems, increasing the efficiency of completing cleaning tasks and/or reducing the number of deployed cleaning systems, thereby reducing the cost of the system.

As will be hereinafter described in more detail, the data acquired on cleaning operations performed by mobile systems 102 may be used to develop tools for designing a cleaning operation for a particular area or municipality. The data will allow the system to “learn” from actual cleaning data, to then develop models of cleaning operations which can be used to design an efficient, optimized cleaning operation for a particular task.

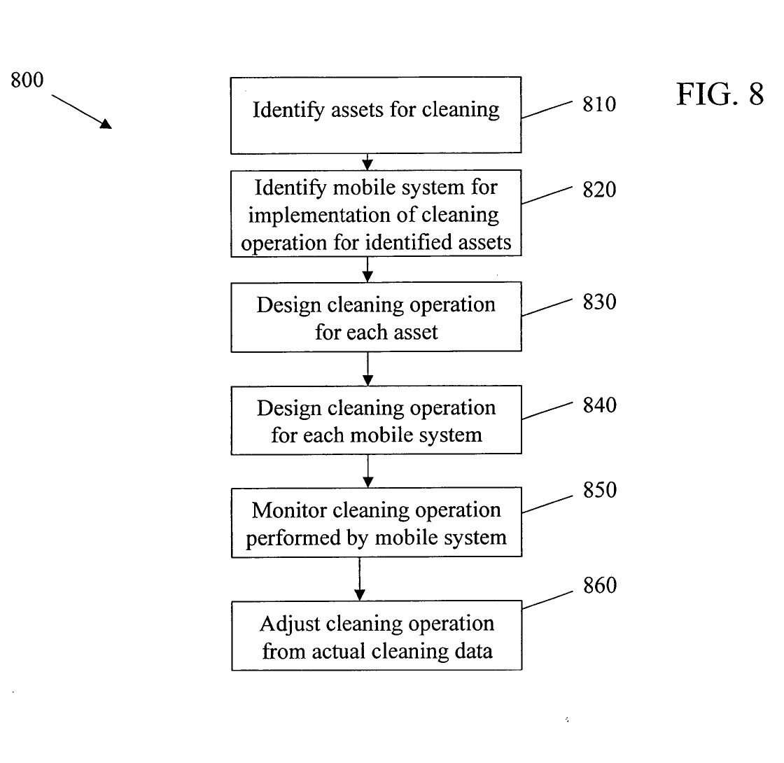

Using the invention, the system can be used to design and perform scheduling of the daily cleaning tasks of the various mobile cleaning systems 102. The systems 102 may be assigned to operators for performing various cleaning operations. As described previously, each mobile cleaning system 102 is equipped with a monitoring system 106. City maps may be provided to the monitoring system 106, and when used in conjunction with the global positioning system (GPS), provide the operator of the mobile cleaning system, as well as the dispatcher, with realtime location information. Furthermore, the route taken by the mobile cleaning system 102 can be recorded, which can then be stored on a central database located at the dispatch center. In tracking the cleaning of a municipality for example, each municipal or city cleaning system to be cleaned can be identified. For example, each area, object or surface to be cleaned by a mobile cleaning system may be represented on a display associated with the monitoring system 106, such as by an icon with an associated number. In designing a cleaning operation, a method 800, as seen in the example of FIG. 8, may be used in accordance with the invention. The “assets” or areas, objects, surfaces or the like, to be cleaned are identified at step 810. As previously mentioned, the monitoring system 106 may include the ability to read barcodes or RFID devices to aid in uniquely identifying assets to be attended to by a mobile cleaning system 102. This will allow the creation and maintenance of records relating to cleaning of each specific asset. Based upon the capabilities of various mobile cleaning systems 102, the invention may then allow identification of a mobile system suited for a particular cleaning task, to be assigned to each cleaning operation to be performed regarding identified assets, at 820. The system may then allow the cleaning operation to be designed for each asset, such as by defining cleaning parameters associated therewith, at 830. Using this information, the cleaning tasks to be performed by each mobile cleaning system 102 may be designed at 840. Implementation of the cleaning operation is performed by the mobile cleaning systems, and using the invention, the cleaning operations performed by each mobile cleaning system may be monitored at 850. Using actual data acquired from such monitoring, the management may then use such data to adjust actual cleaning operations to be performed by the mobile cleaning systems, at 860. It should be recognized that the steps of monitoring and adjustment of a program based on actual operation are not necessary to the aspects of designing a program as described in this embodiment.

In this way, the invention, based upon actual collected data, allows the creation of simulation models relating to the delivery of cleaning services for a different municipality or area. Thus, a computer program product may be supplied to users, to assist in designing a suitable cleaning operation for a particular municipality or area. Thus, given the particulars of a given municipality or area, including the assets thereof to be maintained and cleaned, a user can define particular cleaning operations to be performed by particular mobile cleaning systems 102 as well as the frequency of such operations and other activities such as inspection. Using data acquired by actual operation of the mobile cleaning systems, a user can more accurately define a cleaning system that is optimized for a particular municipality, area or environment.

It should be recognized that according to the invention, cleaning operations performed for municipalities, factories, or the like, can be effectively designed and controlled to optimize use of cleaning system resources and personnel, providing an efficient and cost-effective structure for cleaning and maintenance of municipalities.

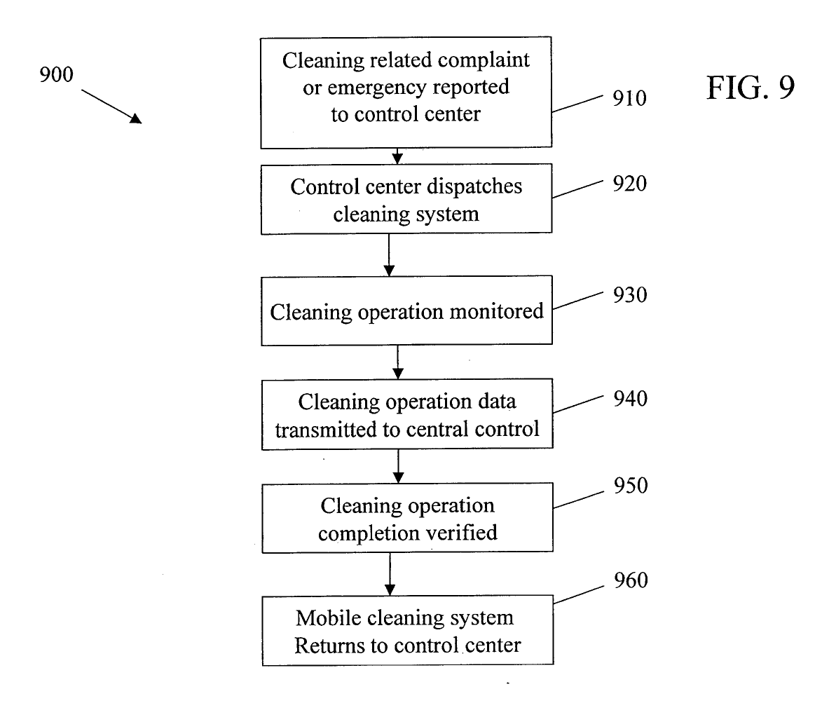

In another example, the invention may be used to allow expedited response to areas requiring cleaning. FIG. 9 illustrates a flowchart of an embodiment of a method to provide a response to a complaint or emergency requiring attention by a mobile cleaning system 102. The method 900 includes, in step 910, the receipt of a cleaning related complaint or other situation requiring cleaning, by a control center. In step 920, the control center dispatches a mobile cleaning system 102, dependent on the nature of the cleaning operation to be performed. The mobile system 102 initiates a cleaning operation and the operation may be monitored at 930. Cleaning operation data is transmitted to the central control at 940, either automatically or at a later time. If desired, the completion of the cleaning operation is verified at 950 and the mobile cleaning system is assigned for other cleaning duties at 960.

The foregoing description of embodiments of the present invention has been provided for the purposes of illustration and description. It is not intended to be exhaustive or to limit the invention to the precise forms disclosed. Obviously, many modification and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A cleaning system configured to monitor cleaning of a municipality, the system comprising:
a central control including a database;
a plurality of mobile cleaning systems, wherein each mobile cleaning system is equipped with a monitoring system and a communication system capable of transmitting and/or receiving data in association with the central control, wherein the monitoring system allows data relating to cleaning operations to be obtained and supplied to the database to facilitate performance of cleaning operations performed by the plurality of mobile cleaning systems.

2. The cleaning system of claim 1, wherein the communication system is a wireless communication system.

3. The cleaning system of claim 1, wherein at least one dispatcher manages the central control.

4. The cleaning system of claim I, wherein the monitoring system further comprises a location determining system for the mobile cleaning system with which it is associated.

5. The cleaning system of claim 1, wherein the monitoring system further comprises a display, and at least one user interface.

6. The cleaning system of claim 1, wherein the monitoring system allows an operator to enter a start time and a completion time relating to a cleaning operation, which is supplied to the database.

7. The cleaning system of claim 1, wherein the mobile cleaning system further comprises a video surveillance camera to monitor the operator or environment where the mobile cleaning system is.

8. The cleaning system of claim 3, wherein the dispatcher is capable of communicating with the operator of a mobile cleaning system.

9. The cleaning system of claim 5, wherein the monitoring system provides a display of an area, surfaces or objects to be cleaned by a mobile cleaning system.

10. The cleaning system of claim 9, wherein the area displayed is a map of at least a portion of a municipality having areas, objects or surfaces to be cleaned noted as icons on the map.

11. The cleaning system of claim 1, further comprising at least one system for uniquely identifying assets to be cleansed by the system.

12. The cleaning system of claim 11, wherein the at least one system for uniquely identifying assets is a bar code reader and/or a RFID receiver.

13. A method for maintaining the cleanliness of a municipality, the method comprising:
selectively deploying a plurality of mobile cleaning systems, wherein each mobile cleaning system is equipped with a monitoring system and a communication system capable of transmitting and/or receiving information, wherein at least one operator is responsible for the operation of each mobile cleaning system to complete at least one cleaning task in a municipality;
selectively recording the location of the mobile cleaning systems;
selectively monitoring the activity of the mobile cleaning systems; and
reporting information relating to the operation of the mobile cleaning systems relating to completion of the cleaning tasks.

14. The method of claim 13, wherein the information reported relates to the time duration for completing a cleaning task, and such information is used in simulation calculations to quantify the time required to complete a similar cleaning task in a different municipality.

15. A method for designing a cleaning program for a municipality, the method comprising:
identifying assets for cleaning,
identifying at least one mobile cleaning system for the cleaning of the assets,
using data relating to cleaning operations performed by a mobile cleaning system to design a cleaning operation for each identified asset,
using the designed cleaning operations to be performed by a mobile cleaning system, designing the cleaning program for each mobile cleaning system.

16. The method of claim 15, wherein each mobile cleaning system is equipped with a monitoring system, and further comprising the step of monitoring the cleaning operations performed by a mobile cleaning system, and adjusting a designed cleaning operation based on such monitoring.

17. The method of claim 15, further comprising the step of providing a monitoring system in association with the mobile cleaning system to uniquely identify an asset for cleaning.

18. A method for maintaining the cleanliness of a municipality, the method comprising: reporting a complaint or an emergency that requires cleaning to a control center;
deploying at least one mobile cleaning system in response to the complaint or emergency, wherein each mobile cleaning system is equipped with a portable monitoring system;
moving the at least one mobile cleaning system to the location relating to the complaint or emergency;
performing the cleaning task with the at least one mobile cleaning system; and
monitoring performance of the cleaning task and allowing the at least one mobile cleaning system to perform other cleaning operations upon completion of the cleaning task associated with the complaint or emergency.

19. A cleaning system comprising:
at least one central control comprising a processing system and database,
at least one mobile cleaning system for cleaning of municipality, the at least one mobile system comprising a processing system and a monitoring system, wherein the operation of the at least one mobile system is monitored by the monitoring system and data is generated relating thereto, with the data communicated to the database of the central control.

20. A method of cleaning an area, comprising the steps of:
providing a central control having a system wherein a plurality of areas or objects within an area are identified for cleaning using at least one mobile cleaning system, the central control communicating with the mobile system to monitor operation of the mobile system, wherein operation is monitored relative to predetermined cleaning operations for the plurality of areas or objects.
